(19) United States
(12) Patent Application Publication
(10) Pub. No.: US 2025/0090914 A1
(43) Pub. Date: Mar. 20, 2025

(54) PICKLEBALL PADDLE AND METHOD

(71) Applicant: POPS PADDLES PTY LTD., Red Hill (AU)

(72) Inventor: Dale YOUNG, Red Hill (AU)

(73) Assignee: POPS PADDLES PTY LTD., Red Hill (AU)

(21) Appl. No.: 18/884,624

(22) Filed: Sep. 13, 2024

(30) Foreign Application Priority Data
Sep. 14, 2023 (AU) 2023902965
Apr. 10, 2024 (AU) 2024901004

(51) Int. Cl. A63B 59/42; A63B 60/54; A63B 102/08; B32B 3/04; B32B 3/12; B32B 3/26; B32B 3/30; B32B 5/02; B32B 7/02

(52) U.S. Cl. CPC A63B 59/42; A63B 60/54; B32B 3/04; B32B 3/12; B32B 3/266; B32B 3/30; B32B 5/02; B32B 7/02; A63B 2102/08; A63B 2209/02; B32B 2250/40; B32B 2260/021; B32B 2260/046; B32B 2307/56; B32B 2307/7376

(57) ABSTRACT

A pickleball paddle comprising: a handle; a ball striking blade formed integrally with the handle; the handle and the blade being formed from a core layer sandwiched between outer layers to form a unitary body; wherein the core layer comprises a thickness which is substantially greater than thickness of the outer layers, said thickness of the core layer being shaped along a peripheral part of the blade and body to form an edge extending between the outer layers of the unitary body; and one or more layers of flexible edge tape being bonded to an outer surface of the edge to at least extend between the outer layers.

### TECHNICAL FIELD

The present invention relates to a novel pickleball paddles and method of making such novel paddles.

### BACKGROUND

Any references to methods, apparatus or documents of the prior art are not to be taken as constituting any evidence or admission that they formed, or form part of the common general knowledge.

Pickleball is one of the fastest growing sports in many parts of the world. Pickleball is played with a flat paddle as opposed to a stringed racket as seen in tennis and badminton. Though the original paddles were cut out of wood by McCallum himself, today's modern versions come in various sizes and thickness levels to accommodate your style of play. The ball used in pickleball is plastic and perforated with anywhere from 26 to 40 holes, similar to a wiffle ball.

Many pickleball paddles have an edge guard added to a pickleball paddle as part of the shaping and moulding process. Usually, the guard is made separately and adhered to a paddle's edge. Without an edge guard, the core of most paddles would be visible and if the edge guard comes loose then the paddle may gradually fall apart. The edge guard protects the side of the paddle from damage and holds the core materials in place. Players can hit the edge of the paddle against the court or other hard surfaces and internal pieces could chip or come loose. Without edge guards, paddles get scraped. The edge guard adds an extra layer of durability to the paddle. The guard is usually made of a hard material that can withstand wear and tear, often plastic, sometimes foam. This means the paddle can last longer and withstand more frequent use without replacement.

In more recent times, edgeless panels have become more common as manufacturers have introduced new paddle designs that eliminate the need for a traditional edge guard. One advantage with edgeless paddles tends to be that they offer a lower swing weight resulting in players having faster reaction times during play. There is a larger flat area to hit the ball, making it easier to hit pure shots on a responsive surface. However, edgeless paddles do have some disadvantages. Currently known edgeless paddles are less durable than paddles which use an edge guard. The lack of the edge guard can make the playing surface around the periphery of the playing surface less impactful. Weight distribution and stability of the paddle during game play is another area of concern. It would be desirable to have an edgeless paddle which offers some of the advantages of the edge guard without the reduced playing surface and the added weight.

### SUMMARY OF INVENTION

In an aspect, the invention may provide a pickleball paddle comprising:
a handle;
a ball striking blade formed integrally with the handle;
the handle and the blade being formed from a core layer sandwiched between outer layers to form a unitary body;
wherein the core layer comprises a thickness which is substantially greater than thickness of the outer layers, said thickness of the core layer being shaped along a peripheral part of the blade and body to form an edge extending between the outer layers of the unitary body; and
one or more layers of flexible edge tape being bonded to an outer surface of the edge to at least extend between the outer layers.

In an embodiment, the said one or more layers of the tape may extend to be flush with respective outer surfaces of the outer layers of the ball striking blade such that no part of the tape covers the outer surface of the blade.

In an embodiment, the said one or more layers of the tape may lap over peripheral portions of the respective outer surfaces of the outer layers of the ball striking blade.

In one or more embodiments, additional layers of the tape may be applied to one or more selected regions of outer layers of the edge for adding perimeter weight or for balancing the paddle. Such a configuration may provide increased twist weight of the paddle thereby reducing the likelihood of the paddle twisting in the player's hands and also improving the overall sweet-spot and performance of the paddle.

In an embodiment, the edge tape may be unidirectional such that the tape is fibre reinforced length-wise to provide directional strength along the edge between the outer layers.

In an embodiment, the edge tape may comprise braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Bassalt, poly methyl methacrylate, polyamide, polyolefins (e.g, polyethylene), polyurethane, and combinations thereof.

In an embodiment, the edge tape seam may comprise pre-pregnated carbon pre-pregnated carbon, Kevlar or fiberglass and may be a single layer of multiple layers of one material or a combination of materials.

In an embodiment, the edge may comprise a concave surface for bonding of the one or more layers of flexible and unidirectional edge tape.

In an embodiment, the core layer may define a hollowed channel extending between peripheral portions of the outer layers, the hollowed channel being filled with settable or curable material to provide said edge.

In an embodiment, the settable or curable material may be enclosed in a flexible material that is impervious to the settable or curable material.

In an embodiment, the core may be formed from one or more of the following materials: polymeric foam, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations

In an embodiment, the core may comprise one or more hollow portions located away from peripheral regions of the core.

In an embodiment, the hollow portions may comprise a plurality of holes located away from the peripheral regions of the core.

In an embodiment, the size of the hollow portions may progressively change in a radially inner direction from outer peripheral portion of the core.

In an embodiment, the hollow portions may extend partially through the core and do not extend across the entire thickness of the core.

In an embodiment, the hollow portions may extend across the entire thickness of the core.

In an embodiment, the core may comprise a honeycomb structure.

In an embodiment, the unitary body may comprise a shock absorbing layer positioned in between the outer layers.

In an embodiment, the core may be sandwiched between two shock absorbing layers wherein each shock absorbing layer being located below a respective outer layer.

In an embodiment, the shock absorbing may be embedded within the core.

In an embodiment, the shock absorbing layer may be sandwiched between two core layers forming the core.

In an embodiment, the outer layers that sandwich the core layer may be comprised of layers of cross laid unidirectional material, a fiber-composite material, a braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Basalt, poly methyl methacrylate, polyamide, polyolefins (e.g, polyethylene), polyurethane, metals, metal alloys and/or combinations thereof.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIGS. 1 to 8B generally illustrate a pickleball paddle 100 in accordance with a first embodiment.

FIGS. 9 to 12C illustrate another alternative embodiment of a paddle 100′.

FIGS. 13 to 19B illustrate another embodiment of a paddle 100″.

FIGS. 20 to 25C illustrate another embodiment of a paddle 100″.

FIGS. 26 to 31B illustrate another embodiment of a paddle 100″.

FIGS. 32 to 34 illustrate another variation of the paddle 100 with additional layers of edge tape 301 in some selected regions of the outer edge.

### DETAILED DESCRIPTION OF PREFERRED EMBODIMENTS

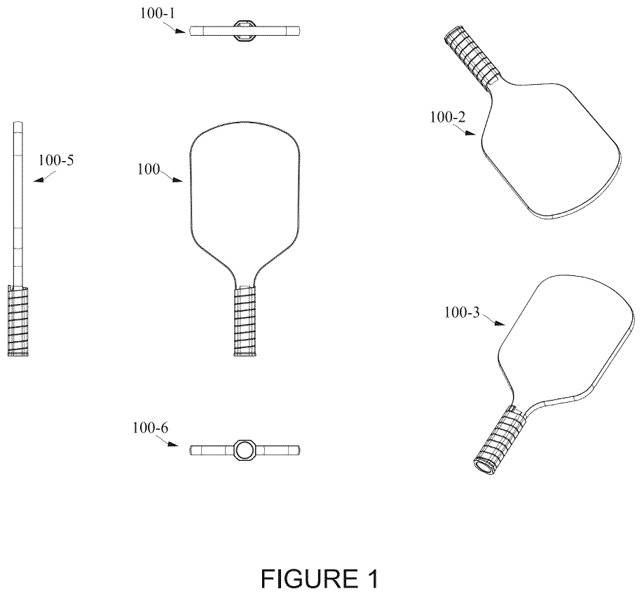

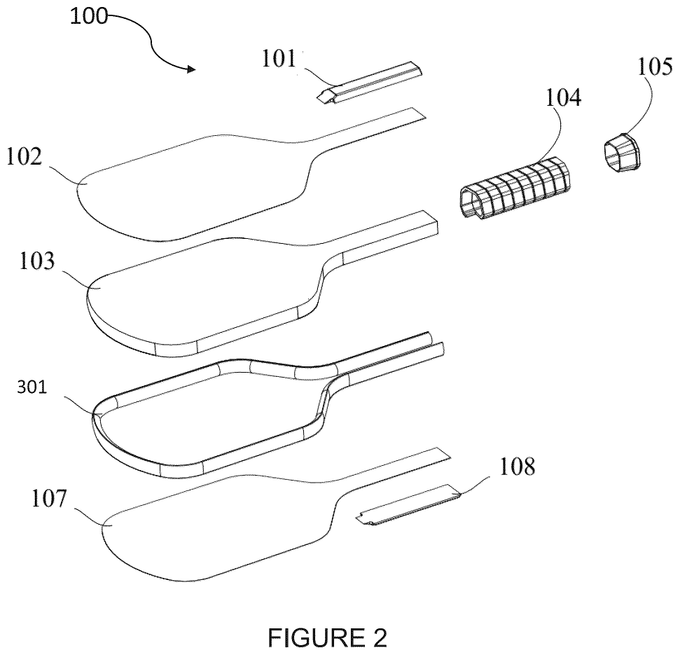

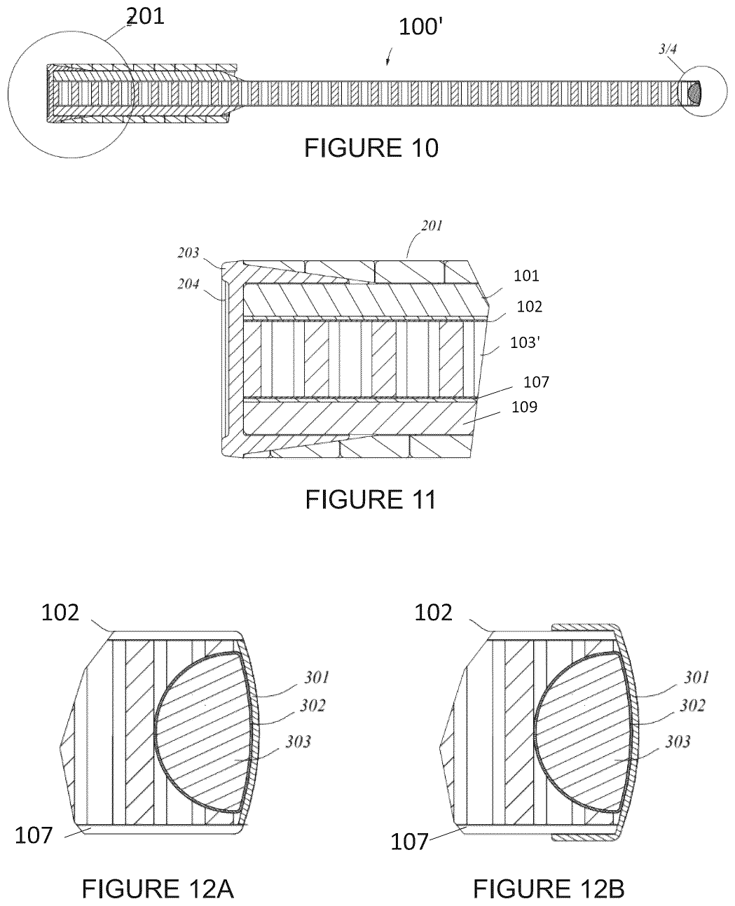

FIGS. 1 to 10 generally illustrate a pickleball paddle 100 in accordance with a first embodiment. In FIGS. 1, 100-1 to 100-6 illustrate various views of the pickleball paddle 100. FIG. 2 illustrates an exploded view of the pickleball paddle 100. The pickleball paddle 100 comprises a core 103 that is sandwiched between two outer layers 102 and 107 which form the playing surface for the paddle 100. In the presently described embodiment, the handle and the ball striking blade for the pickleball paddle are integrally formed by the core 103 sandwiched between the outer layers 102 and 107.

The core 103 in the present embodiment can be made of any one of the following: foam, honeycomb, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations thereof.

The outer layers 102 and 107 form face plates of the paddle 100 and may be formed from layers of cross laid unidirectional material, a fiber-composite material, a braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Basalt, poly methyl methacrylate, polyamide, polyolefins (e.g, polyethylene), polyurethane, metals, metal alloys and combinations thereof. The playing surface for the outer layers 102 and 107 is given a textured finish to impart spin on the ball. A peel ply process may be used to impart the textured finish.

A textured peel ply sheet is applied over a pre-pregnated cloth sheet or multiple layers of cloth sheet. The cloth sheet/s are typically carbon, Kevlar, fiberglass or combinations thereof. In the presently described embodiment, 4 cross-laid sheets per faceplate are being used. In one possible embodiment, 4 sheets of pre-pregnated unidirectional 700K carbon with each sheet laid perpendicular (to the direction of the cloth fibers) to each other may be used. In an alternative embodiment, each outer layer 102 and 107 may comprise 2 or more layers of pre-pregnated cross woven fiberglass.

The cloth sheet/s with the applied peel ply may be cured under temperature and pressure on a flatbed (lamination). Additionally, textured paint (grit added to paint to impart texture) and lasered inscription may also be added to the playing surface for the outer layers 102 and 107.

The detailed manufacturing method will be described in the foregoing sections.

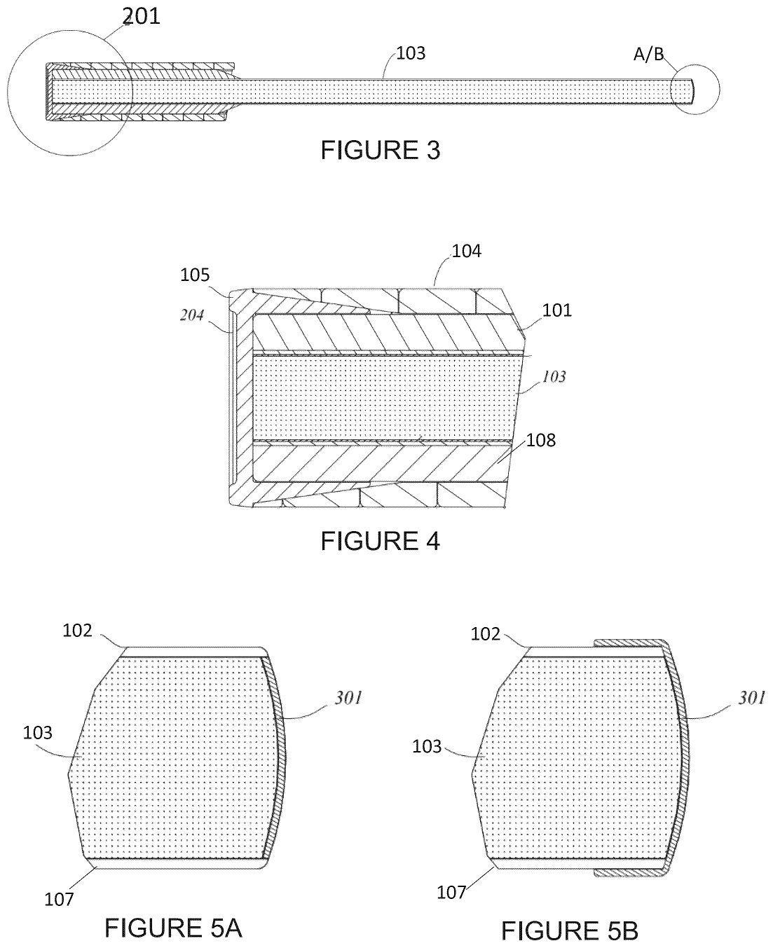

FIGS. 3 to 6 illustrate a first possible edgeless configuration for the paddle 100. As shown in the sectional views, the core layer 103 comprises a thickness which is substantially greater than thickness of the outer layers 102 and 107. The thickness of the core layer 103 is shaped to form a convex edge which extends between the outer layers 102 and 107 all around the paddle 100. The handle portion denoted by 201 comprises handle dampeners 101 and 108 and end cap portion 204 to provide a slightly thicker configuration for the handle 201 relative to the blade portion of the paddle 100.

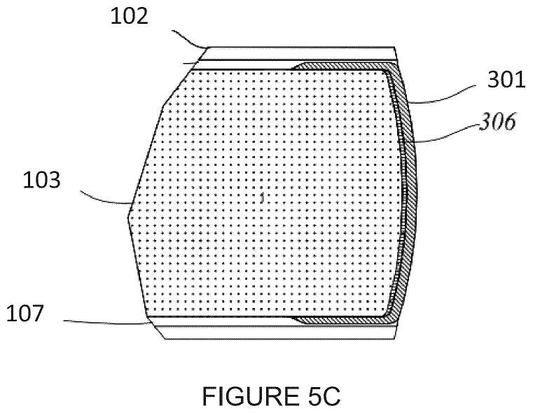

As shown in FIGS. 5A and 5B in particular, one or more layers of flexible edge tape 301 is bonded to the outer convex edge to extend between the outer layers 102 and 107. FIG. 5A shows a first possible embodiment in which the edge tape 301 is flush with the respective outer surfaces of the outer layers 102 and 107. FIG. 5B shows a second possible embodiment in which the edge tape 301 laps over peripheral portions of the respective outer surfaces of the outer layers 102 and 107. FIG. 5C illustrates yet another embodiment in which the edge tape 301 laps over the core layer 103 to be positioned below the respective outer layers 102 and 107.

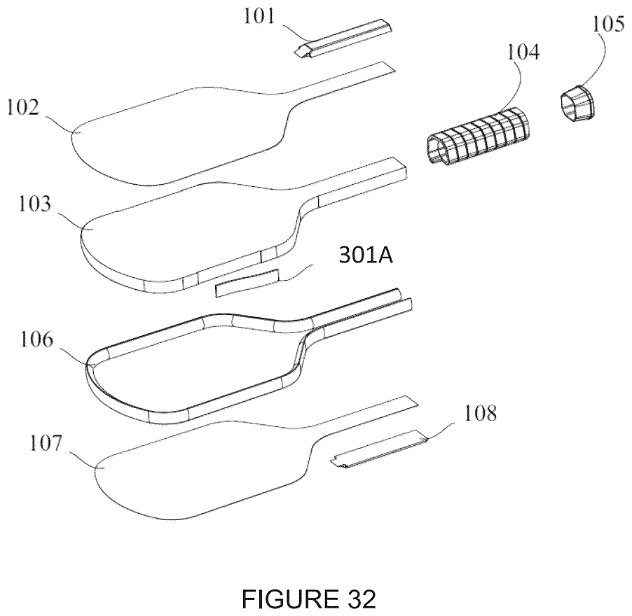

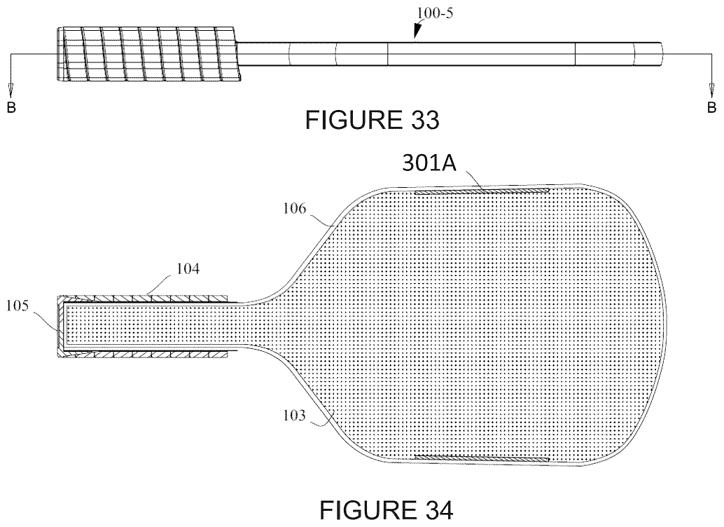

FIGS. 32 to 34 illustrate a variation of the embodiment shown in FIGS. 1 to 6 whereby additional layers of tape 301A are added to selected regions of the outer layers of the edge. The additional layers 301A are applied directly on the edge tape 301. The provision of additional layers of the tape 301 in selected regions of the outer edge for the playing surface not only adds desirable perimeter weight to the blade but also helps balance the paddle 100 during play and can prevent the paddle from spinning in the player's hand.

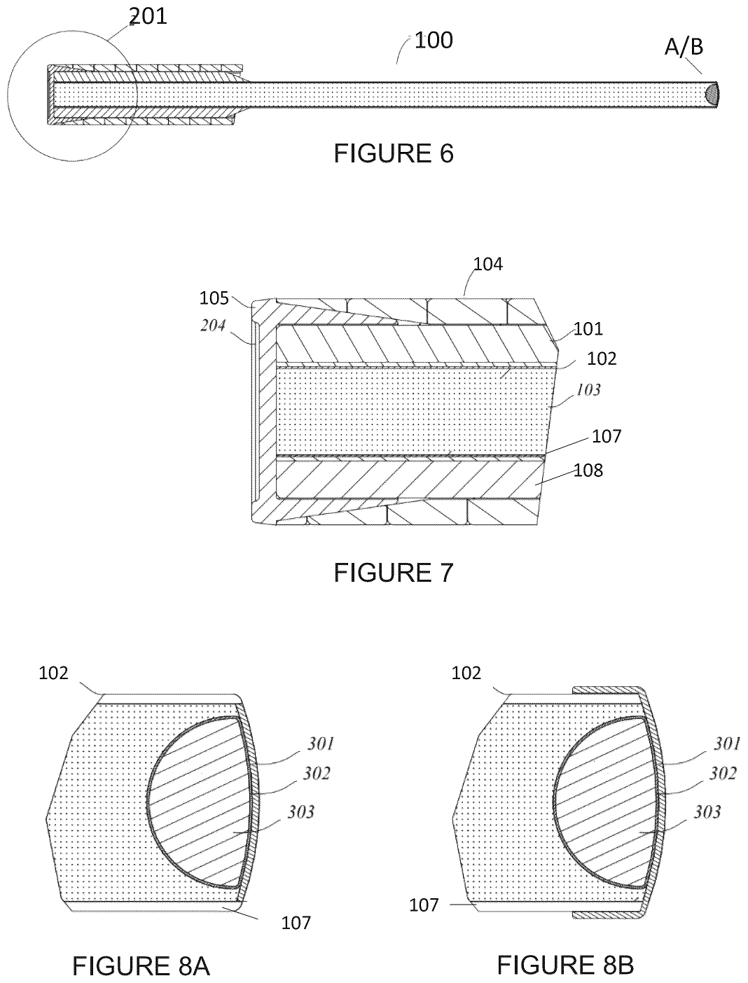

Referring to FIGS. 6 to 8, an alternative configuration for the edgeless paddle 100 has been illustrated. Like reference numerals denote like features that have been previously described. The main difference relates to the formation of the edge for the core 103. Specifically, an arcuate hollow C-shaped channel is formed in the core so that the channel runs along the periphery of the paddle in between the outer layers 102 and 107. A high-density settable material is filled into a roll made of flexible and pre-pregnated fabric and introduced into the C-shaped channel. The provision of the high-density material within a roll of pre-pregnated fabric may be notionally compared to a “sushi roll” 303 that can be filled into the C-shaped channel shown in FIGS. 8A and 8B. The settable and higher density material may be silicon, gel, rubber, foam, gas, rubber-based adhesive, cork, ethylene vinyl acetate (EVA), polymers, acryl-based resins, silicon-based resins, Sorbothane, neoprene, liquid crystal elastomers (LCE), elastic polymers, liquid crystalline polymers, and/or combinations thereof.

The sushi roll 303 in some forms may form a cylinder of shock-absorbing material and/or high density material (compared to the core material) that is wrapped in pre-pregnated cloth (which may be made of either or in combination carbon/Kevlar/fiberglass). The shock-absorbing cylinder which is encased in the rolled pre-pregnated carbon/Kevlar/fiberglass tube is formed around the edge of the paddle core 103 and bonded to the core 103 within the C-shaped channel with any suitable adhesives. The edge tape 301 may be applied in at least two distinct ways.

As shown in FIGS. 8A and 8B in particular, once again one or more layers of flexible edge tape 301 is bonded to the outer convex edge 303 to extend between the outer layers 102 and 107. FIG. 8A shows a first possible embodiment in which the edge tape 301 is flush with the respective outer surfaces of the outer layers 102 and 107. FIG. 8B shows a second possible embodiment in which the edge tape 301 laps over peripheral portions of the respective outer surfaces of the outer layers 102 and 107.

Edge tape 301 can be a unidirectional material, braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Bassalt, poly methyl methacrylate, polyamide, polyolefins (e.g, polyethylene), polyurethane, and combinations thereof. The edge tape 301 may be made preferably from pre-pregnated carbon, Kevlar or fiberglass and may be a single layer of multiple layers of one material or a combination of materials. Preferably, multiple layers of pre-pregnated unidirectional carbon fiber or Kevlar for the edge tape 301.

The manufacturing process for manufacturing the paddle 100 may be carried out in a number of different ways. The manufacturing methods described herein are in no way limiting.

A thermoforming method may be used in a first method embodiment to make the paddle in an Autoclave/Oven. The outer layers 102 and 107 may be prepared in a manner as previously described in the preceding sections. The cured face material on the outer layers 102 and 107 is laminated with a suitable bonding agent. The bonding agents may be selected from Epoxy-based adhesive, Polyester-based resin adhesive, Rubber-based adhesive, Ultra-sonic bonding, Polyurethane and/or Bio Resins thereby forming a reinforcing fabric which has been pre-impregnated with a resin system. The bonding agent may be applied on either side of the core 103 (such as would be a customary when using a laminating machine that may impart temperature and pressure or an open mould press). Once the core 103 and outer layers 102 and 107 are bonded, a CNC method may be used to cut the paddle shape out of the bonded core 103 and outer layers 102 and 107. Alternatively, the face plates 102, 107 and core material 103 can separately be CNC cut into the paddle shape and then laminated together using the bonding agents described above.

The edge tape 301 is either flush bonded parallel to each face plate, or there is a slight overlap onto the surface of each faceplate running the perimeter of the paddle 100 in a manner as previously described. The paddle 100 is placed into an aluminium (metal) die/mould that encompasses the paddle shape. The mould is placed into oven/autoclave at temperature (80-200 C) and pressure to thermoform and set off epoxy adhesives. (at around 110-130 C for 15-20 minutes)). This process sets off the pre-pregnated materials and thermoforms the materials. The mould is removed from the oven/autoclave and allowed to cool. The paddle 100 is then removed from the mould. The edge tape 301 as applied and may be smoothened by sanding or by adding filler. The sanded and smooth edge tape 301 may also be painted and graphics may be printed onto the outer layers 102 and 107. Additionally, the handle dampeners 101 and 108 and the end cap 105 and the grip 104 may also be added to complete manufacturing of the paddle 100.

In another method embodiment, the bonded and CNC cut combination of the core 103 and the outer layers 102 and 107 may be placed into a vacuum bag which may be pressurised (and optionally temperature being elevated) to cure the bonding agents and provide a strong bond. For certain core options (those that are not open cell honeycombs) an additional step of infusion of resin bonding agents may be undertaken to impart a strong bond of all materials and efficient use of bonding agents. The process involves placing the paddle 100 inside a vacuum bag and securely sealing the bag using double-sided ‘tacky tape.’ Subsequently, the vacuum line is connected to a quick-release fitting, and air is extracted from the bag, creating a vacuum with a pressure exceeding-1 bar. Once the vacuum bag is fully sealed, the vacuum line can be disconnected while the bag retains its negative pressure. In cases where heat is needed, the vacuum bag is positioned within a benchtop autoclave prior to initiating the negative pressure. The autoclave is designed with a hole through which the vacuum hose can pass. The vacuum line is attached to the quick-fit connection, following which the autoclave is closed. Essential temperature settings and ramp configurations are then established on the autoclave. Once the bonding is complete, the paddle is removed from the vacuum bag and cleaned up.

In yet another method embodiment, an open moulding method may also be used for manufacturing the paddle 100. The core 103 and the outer layers 102 and 107 once CNC cut and bonded may be placed into an open mould and closed under pressure to provide strong bonding between the core 103 and the outer layers 102 and 107.

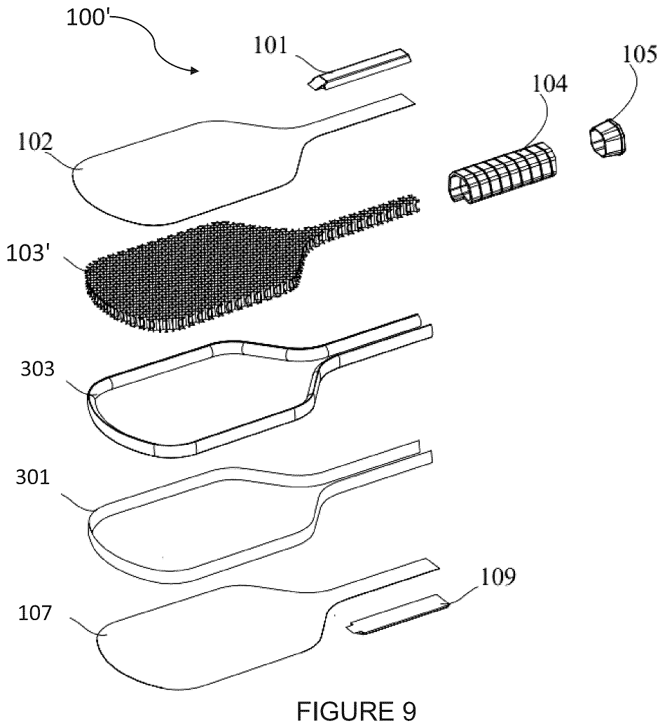

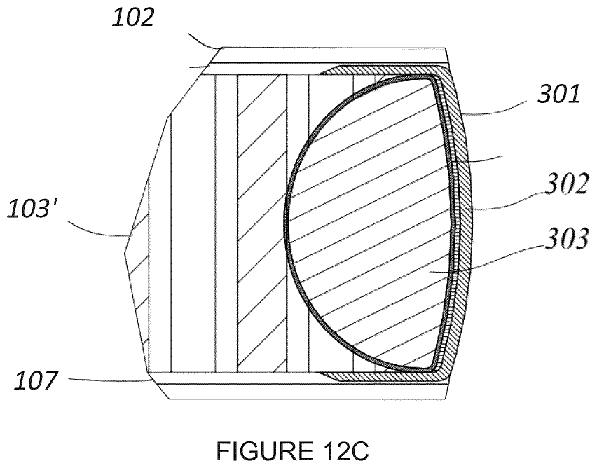

FIGS. 9 to 12 illustrate another alternative embodiment of a paddle 100′. Like reference numerals denote like features that have been previously described and therefore description of the like features has not been repeated. The main difference between paddle 100′ and the previously described paddle 100 relates to the configuration of the core 103. The core 103′ comprises a honeycomb structure as evident from the FIGS. 9-12. The provision of the honeycomb structure provides additional strength and much improved mechanical characteristics to the core 103′. As shown in FIGS. 12A and 12B in particular, one or more layers of flexible edge tape 301 is bonded to the outer convex edge to extend between the outer layers 102 and 107. FIG. 12A shows a first possible embodiment in which the edge tape 301 is flush with the respective outer surfaces of the outer layers 102 and 107. FIG. 12B shows a second possible embodiment in which the edge tape 301 laps over peripheral portions of the respective outer surfaces of the outer layers 102 and 107. FIG. 12C illustrates yet another embodiment in which the edge tape 301 laps over the core layer 103 to be positioned below the respective outer layers 102 and 107.

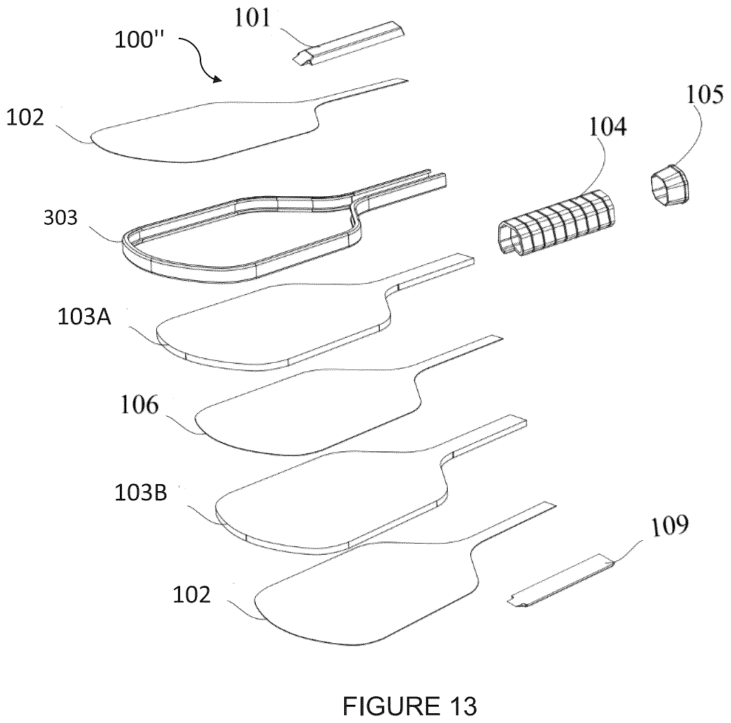

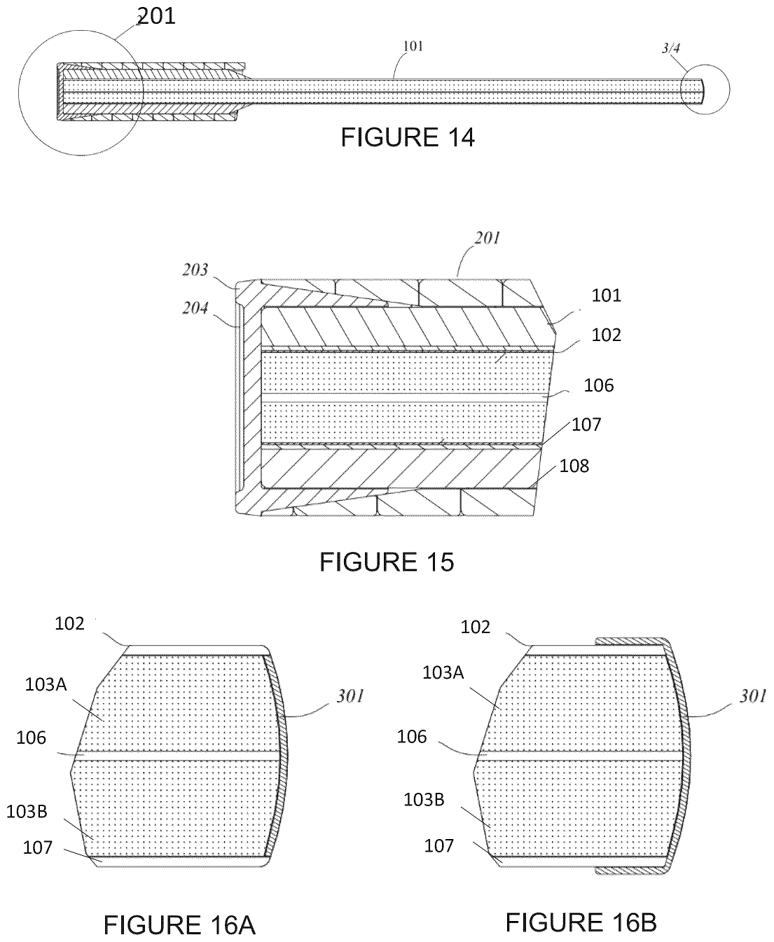

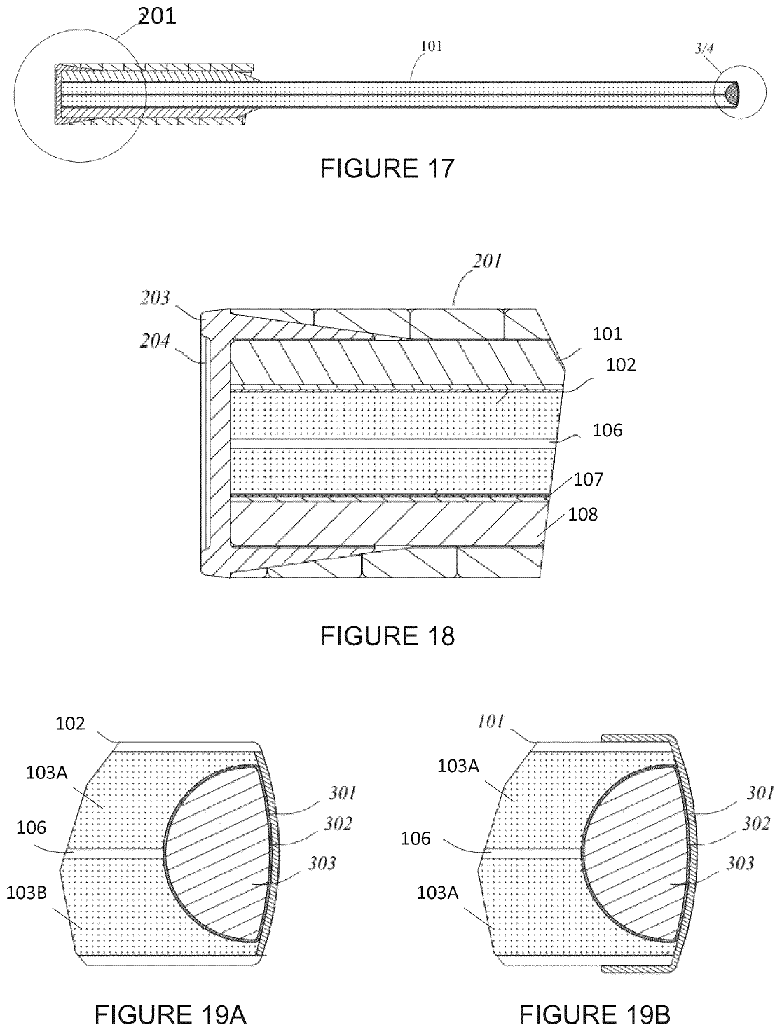

FIGS. 13 to 19 illustrate yet another embodiment of a paddle 100″. Once again, like reference numerals denote like features that have been previously described and therefore description of the like features has not been repeated. The main difference between paddle 100″ and the previously described paddles relates to the configuration of the core 103. The core comprises two core layers 103A and 103B with a layer of shock absorbing material 106 therebetween. The two core layers 103A and 103B may have a similar configuration as core 103 described in the previous sections. The shock absorbing material layer 106 may comprise: a liquid or solid form of silicon, gel, rubber, foam, gas, rubber-based adhesive, cork, ethylene vinyl acetate (EVA), polymers, acryl-based resins, silicon-based resins, Sorbothane, neoprene, liquid crystal elastomers (LCE), elastic polymers, liquid crystalline polymers, and combinations thereof. In an alternative embodiment, the core layers 103A and 103B may comprise shock absorbing material and the middle layer 106 may have a similar configuration as core 103 described in the previous sections. The two different edgeless configurations (shown in FIGS. 5A-5B and 8A-8B) as described in the previous sections may be used for the paddle 100″.

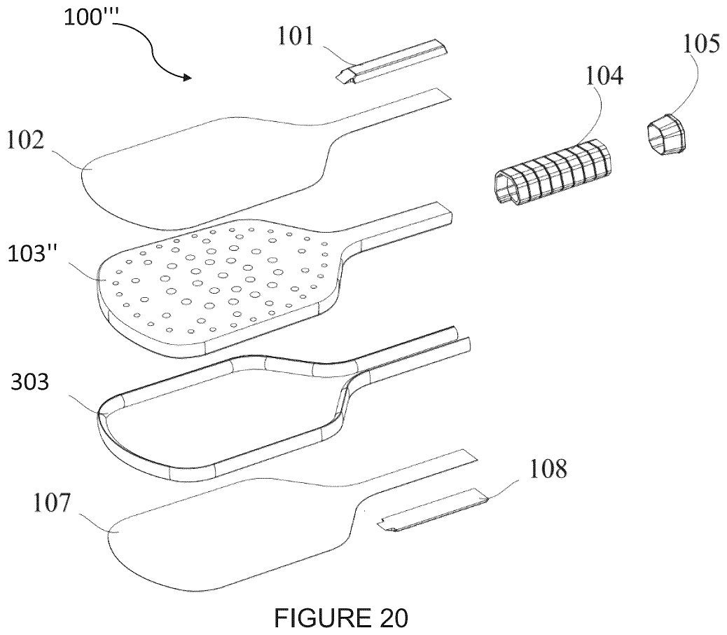

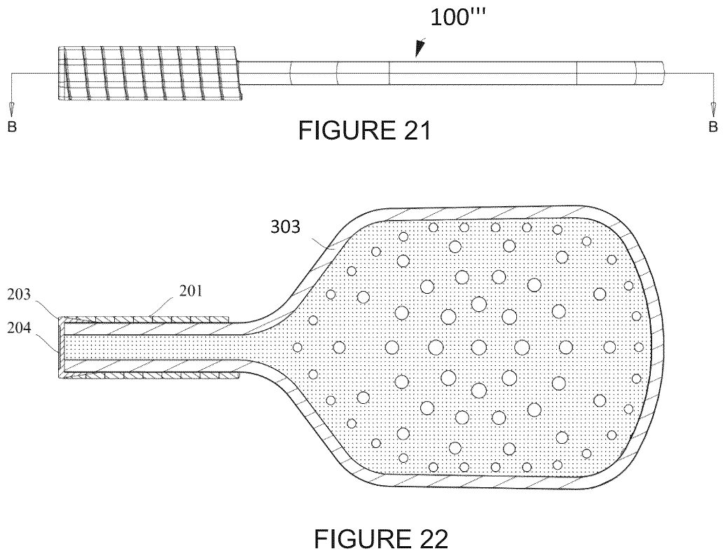

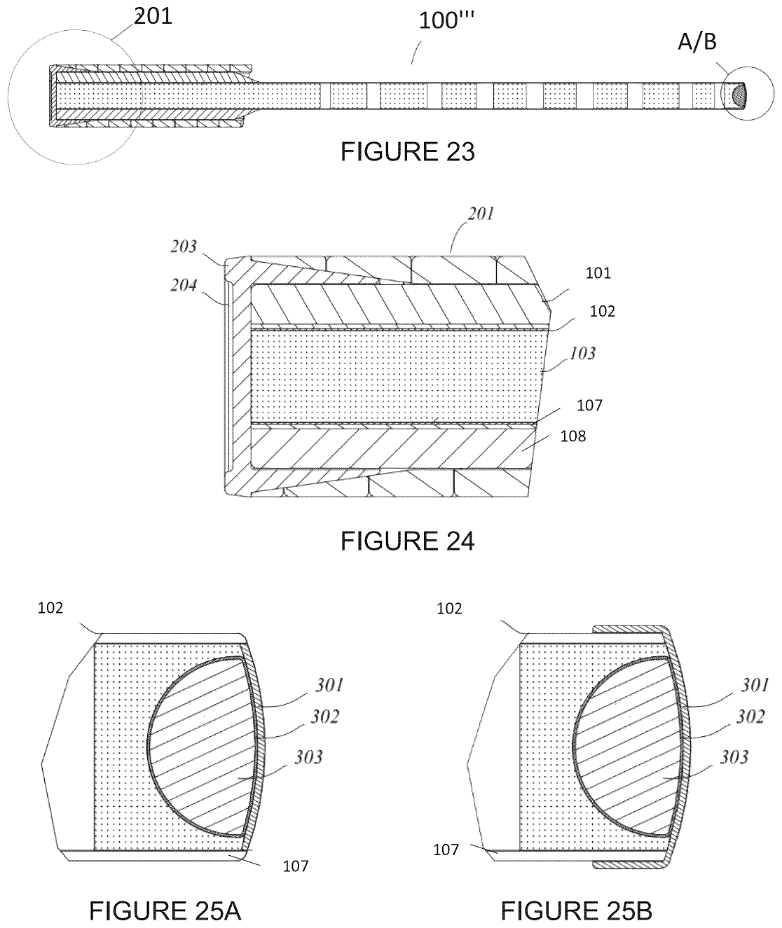

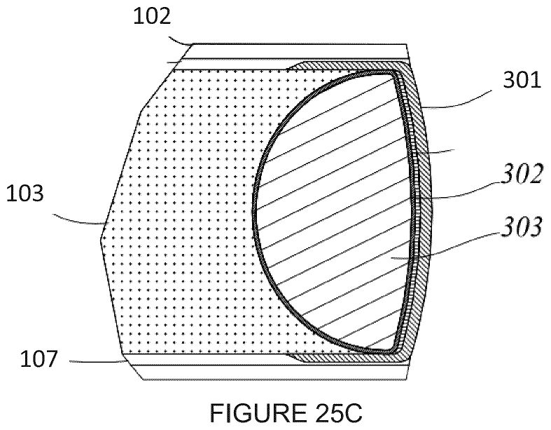

FIGS. 20 to 25 illustrate yet another embodiment of a paddle 100′″. Once again, like reference numerals denote like features that have been previously described and therefore description of the like features has not been repeated. The main difference between paddle 100′ and the previously described paddle 100 relates to the configuration of the core 103. The core 103′ comprises a plurality of holes or openings within the core 103′″ to better manage distribution of weight for the paddle. As shown in FIG. 23, the core 103″ illustrates holes that pass through the entire thickness of the core. However, in other embodiments, the holes may only extend partially into the core 103′″ and not extend all the way across the entire thickness of the core 103″. The size of the holes in the core 103″ may also be varied progressively to become larger or smaller in a direction from the peripheral part of the core to radially inner and central portions of the core 103″. As shown in FIGS. 25A and 25B in particular, one or more layers of flexible edge tape 301 is bonded to the outer convex edge to extend between the outer layers 102 and 107. FIG. 12A shows a first possible embodiment in which the edge tape 301 is flush with the respective outer surfaces of the outer layers 102 and 107. FIG. 25C shows a second possible embodiment in which the edge tape 301 laps over peripheral portions of the respective outer surfaces of the outer layers 102 and 107. FIG. 25C illustrates yet another embodiment in which the edge tape 301 laps over the core layer 103 to be positioned below the respective outer layers 102 and 107.

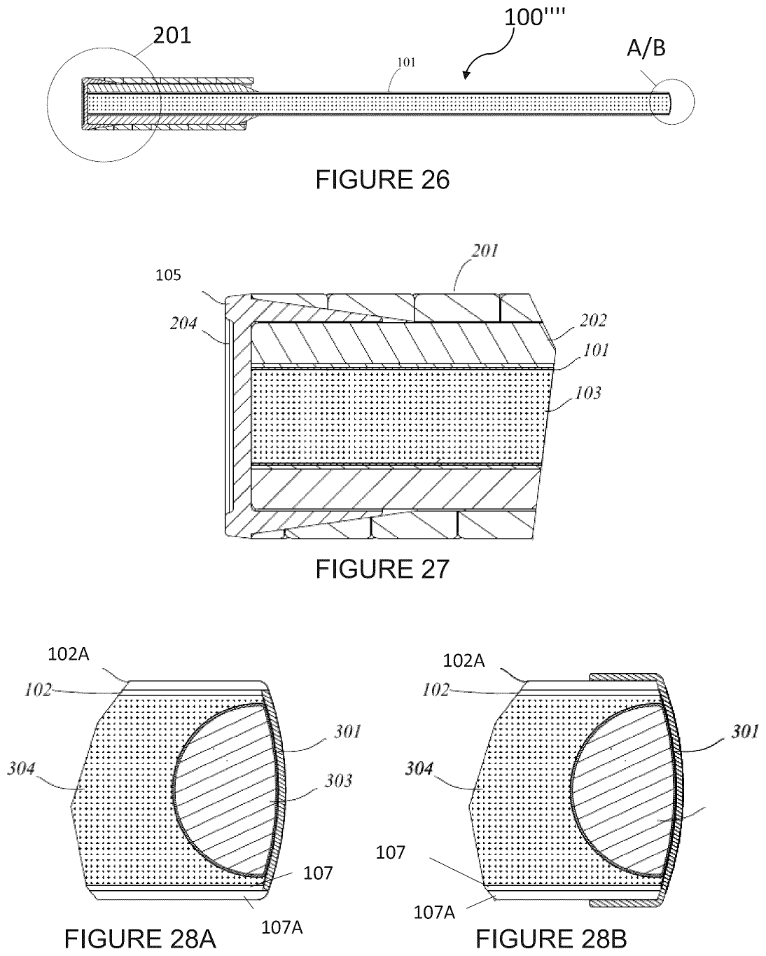

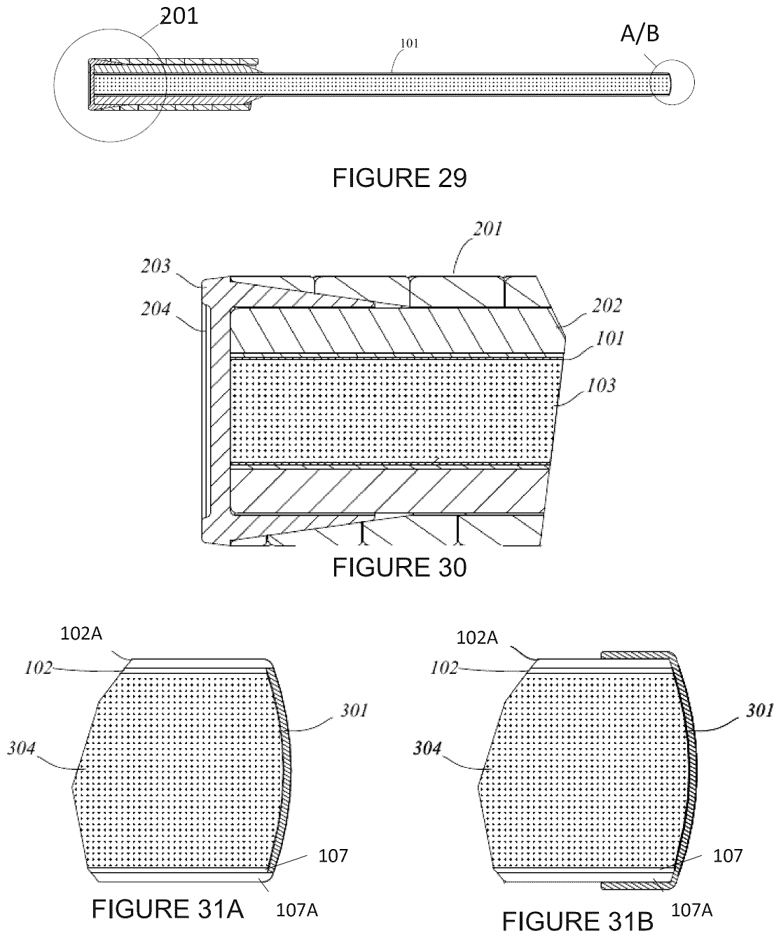

FIGS. 26 to 31 illustrate yet another embodiment of a paddle 100″. Once again, like reference numerals denote like features that have been previously described and therefore description of the like features has not been repeated. Unlike the previously described embodiment, the core 103 comprises two outer layers 102, 102A and 107, 107A for each face of the paddle. The two different edgeless configurations (shown in FIGS. 28A-B and 31A-B) as described in the previous sections may be used for the paddle 100″.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A pickleball paddle comprising:
a handle;
a ball striking blade formed integrally with the handle;
the handle and the blade being formed from a core layer sandwiched between outer layers to form a unitary body;
wherein the core layer comprises a thickness which is substantially greater than thickness of the outer layers, said thickness of the core layer being shaped along a peripheral part of the blade and body to form an edge extending between the outer layers of the unitary body; and
one or more layers of flexible edge tape being bonded to an outer surface of the edge to at least extend between the outer layers.

2. A pickleball paddle in accordance with claim 1 wherein the said one or more layers of the tape extend to be flush with respective outer surfaces of the outer layers of the ball striking blade such that no part of the tape covers the outer surface of the blade.

3. A pickleball paddle in accordance with claim 1 wherein the said one or more layers of the tape to lap over peripheral portions of the respective outer surfaces of the outer layers of the ball striking blade.

4. A pickleball paddle in accordance with claim 1 wherein the edge tape is unidirectional such that the tape is fibre reinforced length-wise to provide directional strength along the edge between the outer layers.

5. A pickleball paddle in accordance with claim 1 wherein the edge tape seam comprises pre-pregnated carbon pre-pregnated carbon, Kevlar or fiberglass and may be a single layer of multiple layers of one material or a combination of materials.

6. A pickleball paddle in accordance with claim 1 wherein the edge comprises a concave surface for bonding of the one or more layers of flexible and unidirectional edge tape.

7. A pickleball paddle in accordance with claim 1 wherein the core layer defines a hollowed channel extending between peripheral portions of the outer layers, the hollowed channel being filled with settable or curable material to provide said edge.

8. A pickleball paddle in accordance with claim 7 wherein the settable or curable material is enclosed in a flexible material that is impervious to the settable or curable material.

9. A pickleball paddle in accordance with claim 1 wherein the core is formed from one or more of the following materials: polymeric foam, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations

10. A pickleball paddle in accordance with claim 1 wherein the core comprises one or more hollow portions located away from peripheral regions of the core.

11. A pickleball paddle in accordance with claim 10 wherein the hollow portions comprise a plurality of holes located away from the peripheral regions of the core.

12. A pickleball paddle in accordance with claim 11 wherein the size of the hollow portions progressively changes in a radially inner direction from outer peripheral portion of the core.

13. A pickleball paddle in accordance with claim 11 wherein the hollow portions extend partially through the core and do not extend across the entire thickness of the core.

14. A pickleball paddle in accordance with claim 11 wherein the hollow portions extend across the entire thickness of the core.

15. A pickleball paddle in accordance with claim 1 wherein the core comprises a honeycomb structure.

16. A pickleball paddle in accordance with claim 1 wherein the unitary body comprises a shock absorbing layer positioned in between the outer layers.

17. A pickleball paddle in accordance with claim 16 wherein the core is sandwiched between two shock absorbing layers wherein each shock absorbing layer being located below a respective outer layer.

18. A pickleball paddle in accordance with claim 16 wherein the shock absorbing is embedded within the core.

19. A pickleball paddle in accordance with claim 18 wherein the shock absorbing layer is sandwiched between two core layers forming the core.

20. A pickleball paddle in accordance with claim 1 wherein additional layers of the tape are applied to one or more selected regions of outer layers of the edge for adding perimeter weight or for balancing the paddle.
